(19) United States
(12) Patent Application Publication
(10) Pub. No.: US 2007/0239472 A1
(43) Pub. Date: Oct. 11, 2007

(54) Vehicle area coverage path planning using isometric value regions

(75) Inventor: Noel Wayne Anderson, Fargo, ND (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/401,120

(22) Filed: Apr. 10, 2006

(51) Int. Cl. G06Q 10/00; G06Q 30/00

(52) U.S. Cl. 705/1

(57) ABSTRACT

A method of optimizing a spatially dependent ground engaging task including the steps of defining a plurality of sub-areas within an area, calculating a cost of performing the task and coalescing cost matrices. The calculating step includes calculating a cost of performing the task for each of the plurality of sub-areas for each of a plurality of times. The cost of each sub-area being an element of one cost matrix of a plurality of cost matrices. Each of the plurality of cost matrices being associated with one of the plurality of times. The plurality of cost matrices including a first cost matrix and a second cost matrix. The coalescing step including coalescing the first cost matrix and the second cost matrix to define an operational path for the performance of the ground engaging task.

### FIELD OF THE INVENTION

The present invention relates to a method of planning a path for ground engaging equipment, and, more particularly to planning a path for ground engaging equipment across subdivisions of a ground area.

### BACKGROUND OF THE INVENTION

The optimal use of equipment is the source of many studies and publications. Environmental factors are often considered in planning optimal solutions for moving equipment and processing ground areas. Optimal area coverage is an important planning activity for agricultural, silviculture, demining and cleaning robots. In agriculture and silviculture issues that have been considered in minimizing a multivariate cost function having factors such as the cost of labor, the cost of machinery, soil damage, by-product damage, harvested material damage, harvested material left on site and harvested material contamination are of concern. In demining, the cost function relates to damage from an undetected mine, where mines are expected based on military intelligence or planter practices and where people are likely to travel in the area of interest and time constraints for cleaning the area. For optimal coverage of cleaning robots the cost function is related to the value of a clean area, where the dirt is likely to be, where people are likely not to be during cleaning and battery recharging needs. Similarly an optimal solution for mowing on golf courses and elsewhere includes consideration of when the grass is adequately dry and people are not present.

Several publications such as Area coverage with cellular decomposition techniques in Robot Motion Planning by Jean-Claude Latombe, Kluwer Academic Publishers, 1991; Area coverage with boustrophedon decomposition in H. Choset and P. Pignon, “Coverage Path Planning: The Boustrophedon Decomposition,” International Conference on Field and Service Robotics, 1997, http://www.ri.cmu.edu/pubs/pub_{—}1416.html; and Solar-based Navigation for Robotic Explorers, a PhD dissertation by Kimberly Shillcutt, Carnegie Mellon University, 2000, http://www.ri.cmu.edu/pubs/pub_{—}3413.html. The cellular decomposition techniques of Latombe do not consider time varying cost functions. The assumption is that one can acceptably be at any place in the coverage area at any time. A focus is on splitting up an area based on an obstacle location into subregions in which coverage is done using a standard pattern such as spiral, back-and-forth (boustrophedon) or contour. Graphic techniques are used to move vehicles from one subregion to another minimizing a simple cost function such as distance.

Shillcutt considers a simple time-varying case of sunlight availability for solar cells on a robotic planetary explorer. The robot must keep its battery charged by being in a sunlit area with its solar cells oriented toward the sun. As such the robot must limit its time in shadows during its explorations. The spatial location of shadows is continuous from their source and can be calculated with great precision in advance if the location of the robot, the location of the sun and the location and shape of shadow casting objects such as a crater rim are known.

What is needed in the art is an approach that considers optimal timing for coverage of discontinuous regions with complex time varying cost functions.

### SUMMARY OF THE INVENTION

The present invention includes a method that arrives at an optimal path for ground engaging equipment by considering time varying costs associated with sub-areas.

The invention comprises, in one form thereof, a method of optimizing a spatially dependent ground engaging task including the steps of defining a plurality of sub-areas within an area, calculating a cost of performing the task and coalescing cost matrices. The calculating step includes calculating a cost of performing the task for each of the plurality of sub-areas for each of a plurality of times. The cost of each sub-area being an element of one cost matrix of a plurality of cost matrices. Each of the plurality of cost matrices being associated with one of the plurality of times. The plurality of cost matrices including a first cost matrix and a second cost matrix. The coalescing step including coalescing the first cost matrix and the second cost matrix to define an operational path for the performance of the ground engaging task.

### BRIEF DESCRIPTION OF THE DRAWINGS

FIG. 1 is a schematical representation of an operational path developed by an embodiment of the present invention; and

FIG. 2 depicts an embodiment of a method of the present invention used to define the operational path of FIG. 1.

### DETAILED DESCRIPTION OF THE INVENTION

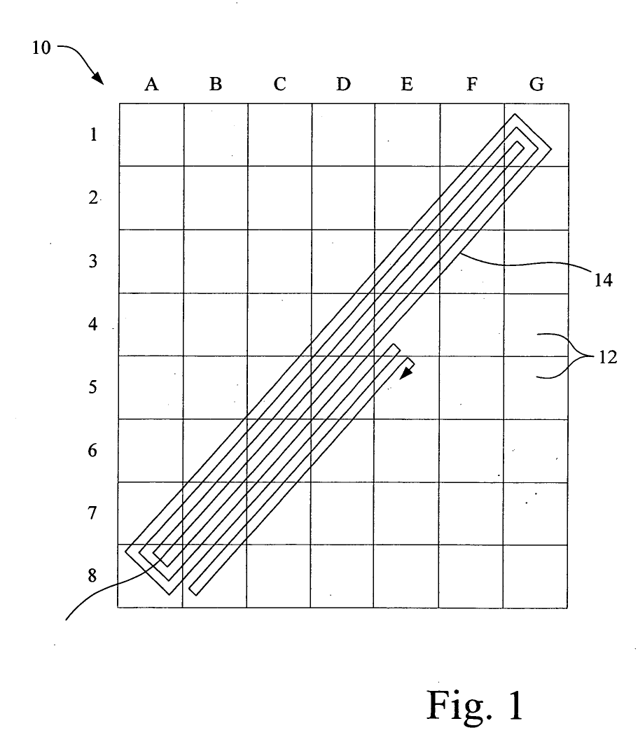

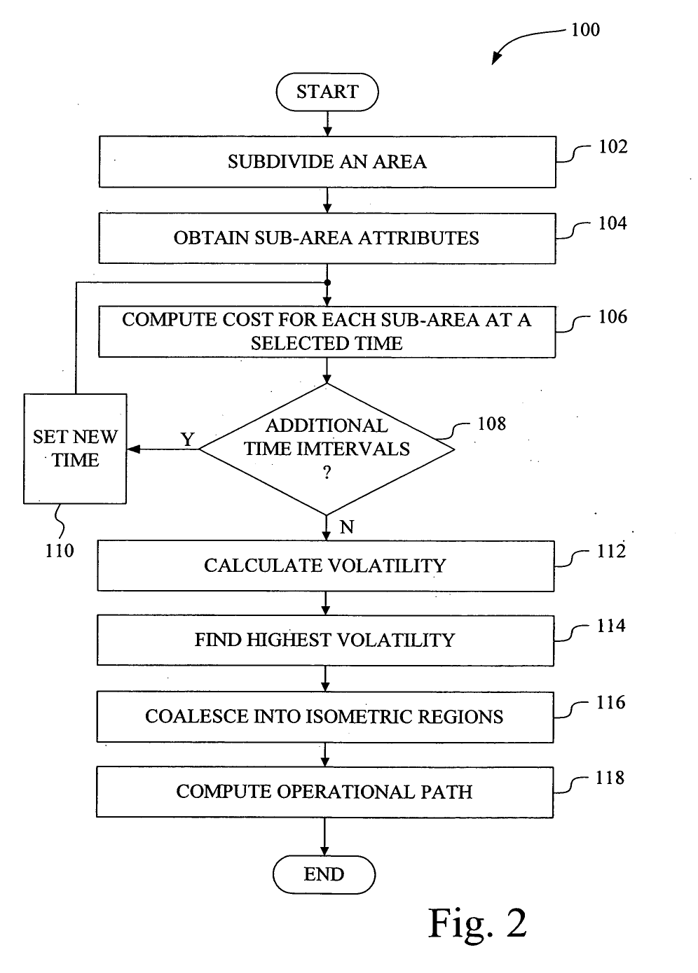

Referring now to the drawings, and more particularly to FIGS. 1 and 2, there is illustrated a method and a result of use of the method in a ground area. Although the present invention may have various applications it is depicted and described as an agricultural operation taking place in a field 10 having sub-areas 12 divided from field 10, with each of sub-areas 12 having soil attributes that are time varying. Further, the present method considers atmospheric and climatic data including weather predictions to be used as inputs into the calculating of an operational path 14 that is time sensitive. Each sub-area 12 has cost factors that include variables as a function of time. For example, soil compaction depends upon soil moisture content that will decrease during a warm, sunny day with a breeze at a predictable rate. Hay quality can vary with humidity and exposure to sunshine during the day. Grain loss can vary as crops dry down and then as the crops are snowed or rained upon. Trees in certain regions of forests and grain in muddy fields may have to wait to be harvested until the ground is frozen, which is a condition that can also change during the course of a day.

The present invention provides a generalized approach to area coverage path planning that considers optimum timing for coverage of discontinuous regions with complex, time varying cost functions. The present invention may be used as part of an operator assistant approach, for force multiplication and for fully autonomous equipment. The actual computations may take place on a processor located on the equipment or one located off of the equipment but connected by way of a communication link. Further the data may be stored on the equipment or at a remote location with the pathway directions being communicated to the equipment. Further, the method can be dynamically recalculated using data that is gathered in field 10 as the equipment traverses the assigned path.

The portion of the present invention that determines isometric value areas can be done utilizing continuous time varying cost functions. To simplify the algorithm for execution on a computer, time varying functions can be evaluated at specific time intervals. While the algorithm of the present method can be utilized to consider an entire crop season and multiple fields with appropriate multivariate cost functions, for the purposes of clarity and explaining the present invention, only a single field 10 on a single day is illustrated and described. The method can be extended by considering field 10 to be a subregion of an entire farm and by extending the time intervals over a day to time intervals over an entire crop year. Again, while agriculture is the example described as utilizing the present invention, it can be applied to forestry, demining, turf care, cleaning and other area coverage applications with multivariate time varying cost factors.

As the ground engaging equipment enters field 10 on a side of grid A8 operational path 14 has been determined to take a course that causes the ground engaging equipment to proceed to grid G1 and then return to grid A8 traversing several sub-areas 12 in the process. The method of the present invention coalesces adjacent sub-areas 12 of various grid coordinates into an isometric region having substantially similar cost values associated with each sub-areas 12. If for example, a high cost value is assigned to sub-area F4, path 14 would be optimized to not enter grid area F4 until the cost of entering F4 was minimized relative to the time constraints utilized in planning operational path 14 within field 10. The details that follow will illustrate another operational path 14 taken within a field 10 with similar grid coordinates.

For purposes of explaining the method of the present invention it is assumed that a planting operation will be undertaken in field 10, which is planned to be completed between the hours of 7 am and noon. Field 10 has a ridge with two low lying areas. One low lying area faces the southeast (toward grid G8) and the other low lying area faces northwest (toward grid area A1). It has rained recently, leaving the low areas wetter than desired for immediate planting. The weather forecast for the day is sunny and warm with a warm breeze out of the south. A general time varying cost function for the work is expressed as:
cost(t)=labor(t)+machinery(t)+stand damage(t)+soil damage(t)
These terms are associated with a planting operation and alternate terms would be utilized with different types of operations to determine the cost relative to an operation within a particular sub-area 12. It is assumed that the labor and machinery costs will be constant throughout the day and are dropped from the illustration, although labor and machinery costs that are found to vary by time can also enter into the calculation. The stand damage includes elements relative to seed placement and seed/soil contact. The soil compaction damage is a function of soil moisture that decreases during the day. Using remotely sensed data, topography maps, weather forecast and a soil model, a time varying soil moisture map can be calculated using techniques, such as evapotranspiration models, which can be found in the crop and soil science literature. Yield loss functions can be obtained from crop science literature. Crop cost equations of:
stand damage(t)=yield loss(soil moisture(t))*crop price/bushel
soil damage(t)=yield loss(compaction(soil type, soil moisture(t))*crop price/bushel,
which are dependent upon time and have a cost value associated therewith.

For this example, field 10 is divided spatially into an 8×7 grid and into five layers or calculations separated by one hour projected intervals. For a sequence of intervals a calculation of sub-areas 12 within field 10 yield a matrix of values for completing the ground engaging task during the interval. The elements of the matrices correspond to computed values for each sub-area 12. The equation utilized is:
Cost$(t)=stand damage$(t)+soil damage$(t)

The numbers in each of the cells of the following matrices are for one hour time intervals starting at 7:00 am through 11:00 am:

7:00 AM

| | A | B | C | D | E | F | G |
|---|---|---|---|---|---|---|---|
| 1 | 55 | 55 | 45 | 35 | 25 | 10 | 00 |
| 2 | 55 | 55 | 45 | 30 | 15 | 05 | 00 |
| 3 | 45 | 45 | 30 | 20 | 10 | 00 | 00 |
| 4 | 45 | 30 | 20 | 15 | 00 | 05 | 15 |
| 5 | 40 | 30 | 20 | 00 | 05 | 15 | 25 |
| 6 | 30 | 20 | 00 | 05 | 15 | 25 | 35 |
| 7 | 20 | 00 | 05 | 15 | 25 | 35 | 35 |
| 8 | 00 | 05 | 15 | 25 | 35 | 35 | 35 |

8:00 AM

| | A | B | C | D | E | F | G |
|---|---|---|---|---|---|---|---|
| 1 | 50 | 50 | 40 | 30 | 20 | 05 | 00 |
| 2 | 50 | 50 | 40 | 25 | 10 | 00 | 00 |
| 3 | 40 | 40 | 25 | 15 | 05 | 00 | 00 |
| 4 | 40 | 25 | 15 | 10 | 00 | 00 | 05 |
| 5 | 35 | 25 | 15 | 00 | 00 | 05 | 15 |
| 6 | 25 | 15 | 00 | 00 | 05 | 15 | 25 |
| 7 | 15 | 00 | 00 | 05 | 15 | 25 | 25 |
| 8 | 00 | 00 | 05 | 15 | 25 | 25 | 25 |

9:00 AM

| | A | B | C | D | E | F | G |
|---|---|---|---|---|---|---|---|
| 1 | 45 | 45 | 35 | 25 | 15 | 00 | 00 |
| 2 | 45 | 45 | 35 | 20 | 05 | 00 | 00 |
| 3 | 35 | 35 | 20 | 10 | 00 | 00 | 00 |
| 4 | 35 | 20 | 10 | 05 | 00 | 00 | 00 |
| 5 | 30 | 20 | 10 | 00 | 05 | 00 | 05 |
| 6 | 20 | 10 | 00 | 00 | 00 | 05 | 15 |
| 7 | 10 | 00 | 00 | 00 | 05 | 15 | 15 |
| 8 | 00 | 00 | 05 | 05 | 15 | 15 | 15 |

10:00 AM

| | A | B | C | D | E | F | G |
|---|---|---|---|---|---|---|---|
| 1 | 35 | 35 | 25 | 15 | 05 | 00 | 00 |
| 2 | 35 | 35 | 25 | 10 | 00 | 00 | 00 |
| 3 | 25 | 25 | 10 | 00 | 00 | 00 | 00 |
| 4 | 25 | 10 | 00 | 00 | 00 | 00 | 00 |
| 5 | 20 | 10 | 00 | 00 | 00 | 00 | 00 |
| 6 | 10 | 00 | 00 | 00 | 00 | 00 | 00 |
| 7 | 00 | 00 | 00 | 00 | 00 | 00 | 00 |
| 8 | 00 | 00 | 00 | 00 | 00 | 00 | 00 |

11:00 AM

| | A | B | C | D | E | F | G |
|---|---|---|---|---|---|---|---|
| 1 | 25 | 25 | 15 | 05 | 00 | 00 | 00 |
| 2 | 25 | 25 | 15 | 00 | 00 | 00 | 00 |
| 3 | 15 | 15 | 00 | 00 | 00 | 00 | 00 |
| 4 | 15 | 00 | 00 | 00 | 00 | 00 | 00 |
| 5 | 00 | 00 | 00 | 00 | 00 | 00 | 00 |
| 6 | 00 | 00 | 00 | 00 | 00 | 00 | 00 |
| 7 | 00 | 00 | 00 | 00 | 00 | 00 | 00 |
| 8 | 00 | 00 | 00 | 00 | 00 | 00 | 00 |

The values assigned to the cost matrices for each of the time periods shows the varying cost associated with each sub-area 12 as a drying breeze removes moisture from the soil, thereby reducing the cost to the value of the produced crop as the day goes on. Considering each sequence of intervals the calculation is made of the volatility of the values for each grid over the sequence of intervals. One method of determining the volatility of the grid is to subtract the maximum values from the minimum values over the allotted time periods. For example, a volatility matrix may be calculated as:
Volatility=Max value−Minimum values.

Other functions beside subtracting the minimum value from the maximum value may be utilized to calculate the volatility grid values. In general the max values and minimum values may not occur at the same time, however, for clarity of the example it has been assumed that the minimum values occur at 11:00 am, the maximum values occur at the 7:00 am time periods. Areas with higher volatility should be given preference for working at that location at the minimum cost time, while areas with lower volatility are less value sensitive to being visited at their minimum cost time. Utilizing the volatility equation results in the volatility matrix:

Volatility

| | A | B | C | D | E | F | G |
|---|---|---|---|---|---|---|---|
| 1 | 30 | 30 | 30 | 30 | 25 | 10 | 00 |
| 2 | 30 | 30 | 30 | 30 | 15 | 05 | 00 |
| 3 | 30 | 30 | 30 | 20 | 10 | 00 | 00 |
| 4 | 30 | 30 | 20 | 15 | 00 | 05 | 15 |
| 5 | 30 | 30 | 20 | 00 | 05 | 15 | 25 |
| 6 | 30 | 20 | 00 | 05 | 15 | 25 | 35 |
| 7 | 20 | 00 | 05 | 15 | 25 | 35 | 35 |
| 8 | 00 | 05 | 15 | 25 | 35 | 35 | 35 |

Starting with the sub-areas 12 having the highest volatility the present method determines the optimal time for moving the equipment into the area of highest volatility. Sub-areas having similar values are coalesced into regions with value and time limits and/or areas restrictions relating to minimum or maximum sizes. The coalescing of grids result in isometric value regions relative to a combination of sub-areas 12 for particular periods of time. Areas without much cost volatility can form isometric regions that span the entire time sequences. For purposes of this example similarly valued sub-areas are grouped such as variations of no more than $5.00 per sub-area 12 and at most a cost of +/−$10.00 of value. For purposes of this example, a target minimum number of sub-areas 12 to be traversed is set at a minimum of four sub-areas and a maximum of fourteen that can be planted in a one hour interval. The coalescing algorithm starts with the most volatile grid elements followed by the earliest least volatile grid elements. The determining of time sensitive operational path 14 additionally includes considering turning constraints of the equipment and width of the ground engaging process for calculating the efficient covering of the area at minimum cost. From the volatility matrix it can be seen that the maximum volatility is 35 and includes sections E8, F7, F8 and G6-8. In looking at these most volatile regions it can be seen that the cost associated therewith is at a minimum in the 10:00 and 11:00 intervals. The next largest unvisited volatility is 30 that occurs in grids A1-6, B1-5, C1-3 and B1 and 2. The most volatile areas of the field reach their minimum cost in the 10:00 to 11:00 time sequences and the least volatile areas achieve their minimum cost earlier. However, all five hours are required to do the fieldwork. As such, less volatile areas should be done earlier in the day as they reach minimum cost.

The method identifies the areas having no cost or $5.00 cost as an initial area to begin the operation. The operation starts at 7:00 am and priority is given to the areas having zero cost and zero volatility. Since the areas having values of $0 and $5.00 amount to fifteen areas at 7:00 am this exceeds the maximum fourteen units that can be planted in one hour. As such priority is given to the zero value sub-area to minimize the accrued cost. This continues over the time intervals as the field is planted with a priority given to moving to the next closest region when one region has been completed. At each interval of time standard field patterns such as boustrophedon, contour and spiral may be used by the equipment as well as consideration and coordination with multiple vehicles performing the task. If adjacent sub-areas 12 are not connected a planning of operational path 14 can include the minimum length crossbridge for the traversal over either high cost or completed sub-areas 12. If multiple pieces of equipment are operating in field 10 the characteristics of the equipment to be utilized are part of the calculations to determine the cost of utilizing those particular pieces of equipment to optimize the paths of the particular pieces of equipment performing the work. For example, one equipment piece may have more traction capability than another or may have lower compaction due to its configuration.

Additionally, once sub-areas 12 are identified as isometric areas the areas may contain obstacles which are avoided by way of the operational path algorithm.

As a comparison of the cost savings if it were assumed that the planter is able to plant twelve units per hour and moved in a north/south pattern starting in grid

| | | |
|---|---|---|
| 7:00 | 00 + 20 + 30 + 40 + 45 + 45 + 55 + 55 + 55 + 55 + 45 + | 475 |
| | 30 = | |
| 8:00 | 25 + 15 + 00 + 00 + 05 + 00 + 00 + 15 + 15 + 25 + 40 + | 180 |
| | 40 = | |
| 9:00 | 25 + 20 + 10 + 05 + 00 + 00 + 00 + 05 + 15 + 05 + 00 + | 90 |
| | 05 = | |
| 10:00 | 00 + 00 + 05 + 00 + 00 + 00 + 00 + 00 + 00 + 00 + 00 + | 5 |
| | 00 = | |
| 11:00 | 00 + 00 + 00 + 00 + 00 + 00 + 00 + 00 = | 0 |

In contrast using the method of the present invention the costs are $380.00 or roughly half of a standard back and fourth pattern, which may be applied to the whole field, as shown in the following cost/hour:

| | |
|---|---|
| 7:00 | 25 |
| 8:00 | 70 |
| 9:00 | 50 |
| 10:00 | 45 |
| 11:00 | 190 |

Another view of the present method of the invention includes the steps of subdividing an area at step 102. The sub-area attributes are obtained at step 104, which may include characteristics of the soil drainage ability, its exposure to sun over the course of the day, the direction of the wind over a particular sub-area, the forecast for the weather over a set time period, the types of soil, and compaction attributes each of which are obtained prior to entering field 10. Further attributes are obtained while operating in field 10, such as slippage of the earth engaging wheels and other in situ elements of field 10 and more particularly sub-areas 12. At step 106 a cost of operating in each sub-area 12 is calculated for a particular time. Even though the time intervals utilized in the above example are one hour increments other increments of time can be utilized. Further, as data is gathered by the ground engaging equipment, as it traverses sub-areas 12, the cost of each sub-area can be modified with further planning. At steps 108 and 110 it is determined how many time intervals are to be calculated and new time intervals are set for computing of cost of each sub-area for each of the selected time intervals. The cost volatility is calculated at step 112 to establish a matrix of volatile values so that the highest volatility can be found at step 114. At step 116, areas of similar cost with lowest volatility are coalesced into isometric regions, which can be thought of as similar cost sub-areas 12. Utilizing the coalesced isometric regions the method then computes an operational path, at step 118, in field 10 that operates the ground engaging equipment over a course that minimizes the cost associated with the operation in field 10. Although path 14 has been shown as linear and sub-areas 12 have been illustrated as squares within a grid, other divisions of field 10 are also contemplated. For example, evaluation of attributes in areas along an initial path may be reevaluated to correspond to the current calculated paths of the ground engaging vehicle. Further, although sub-areas 12 have been illustrated as having substantially the same area, different areas can be utilized and would be part of the attributes of each sub-area 12. Attributes of the soil may be obtained from past historical values as well as non-contact and/or sensor systems arrayed within field 10.

Having described the preferred embodiment, it will become apparent that various modifications can be made without departing from the scope of the invention as defined in the accompanying claims.

### Assignment

The entire right, title and interest in and to this application and all subject matter disclosed and/or claimed therein, including any and all divisions, continuations, reissues, etc., thereof are, effective as of the date of execution of this application, assigned, transferred, sold and set over by the applicant(s) named herein to Deere & Company, a Delaware corporation having offices at Moline, Ill. 61265, U.S.A., together with all rights to file, and to claim priorities in connection with, corresponding patent applications in any and all foreign countries in the name of Deere & Company or otherwise.

1. A method of optimizing a spatially dependent ground engaging task, comprising the steps of:
defining a plurality of sub-areas within an area;
calculating a cost of performing the task for each of said plurality of sub-areas for each of a plurality of times, said cost of each sub-area being an element of one cost matrix of a plurality of cost matrices, each of said plurality of cost matrices being associated with one of said plurality of times, said plurality of cost matrices including a first cost matrix and a second cost matrix; and
coalescing said first cost matrix and said second cost matrix to define an operational path for the performance of the ground engaging task.

2. The method of claim 1, further comprising the step of repeating said coalescing step with said plurality of cost matrices thereby further refining said operational path.

3. The method of claim 2, wherein said operational path extends through a set of said plurality of sub-areas a plurality of times.

4. The method of claim 1, wherein said coalescing step coalesces a selected set of said sub-areas, said selected set including sub-areas of proximate cost values.

5. The method of claim 4, wherein said coalescing step includes using constraints of at least one of time limits, minimum number of sub-areas and sizes of said sub-areas to define isometric value regions.

6. The method of claim 5, wherein said operational path starts in a low-cost one of said isometric value regions.

7. The method of claim 6, wherein said coalescing step starts with highest volatile values in said cost matrices.

8. The method of claim 7, wherein said coalescing step includes an identification of earliest least volatile sub-areas.

9. The method of claim 1, wherein at least some of the steps are repeated while the ground engaging task is occurring in said area.

10. The method of claim 1, wherein at least one of atmospheric attributes, weather projections and soil attributes each of which are projected to vary over time are used in said calculating step.

11. A method of obtaining a least-cost solution for a ground engaging task, comprising the steps of:
subdividing an area into a plurality of sub-areas;
computing a cost of performing the ground engaging task in each of said plurality of sub-areas for a projected future time;
repeating said computing step for a plurality of future times thereby creating a plurality of costs for each sub-area relative to said plurality of future times; and
using said plurality of costs to define a time sensitive operational path for ground engaging equipment.

12. The method of claim 11, wherein said using step includes the step of coalescing at least some of said plurality of costs for adjacent sub-areas to define said time sensitive operational path.

13. The method of claim 12, wherein said time sensitive operational path extends through a set of said plurality of sub-areas.

14. The method of claim 13, wherein said coalescing step coalesces said set of said plurality of sub-areas, said set including sub-areas of proximate cost.

15. The method of claim 14, wherein said coalescing step includes using constraints of at least one of time limits, minimum number of sub-areas and sizes of said sub-areas to define isometric value regions.

16. The method of claim 15, wherein said time sensitive operational path starts in a low-cost one of said isometric value regions.

17. The method of claim 16, wherein said coalescing step starts with highest volatile values of said costs of said sub-areas.

18. The method of claim 17, wherein said coalescing step includes an identification of earliest least volatile sub-areas.

19. The method of claim 11, wherein at least some of said steps are repeated while the ground engaging task is underway in said area.

20. The method of claim 11, wherein at least one of atmospheric attributes, weather projections and soil attributes each of which are projected to vary over time are used in said computing step.
